(19) United States
(12) Patent Application Publication
(10) Pub. No.: US 2008/0246316 A1
(43) Pub. Date: Oct. 9, 2008

(54) CHILD RESTRAINT SYSTEM INCLUDING TENSION SENSOR AND STATUS INDICATOR

(76) Inventors: David Shaun Carine, Hampshire (GB); Michael Hudswell, Nottinghamshire (GB); David Gardiner Downie, Hampshire (GB)

Correspondence Address: ADAMS INTELLECTUAL PROPERTY LAW, P.A., Suite 2350 Charlotte Plaza, 201 South College Street, CHARLOTTE, NC, 28244, US

(21) Appl. No.: 11/767,174

(22) Filed: Jun. 22, 2007

Related U.S. Application Data
(60) Provisional application No. 60/909,746, filed on Apr. 3, 2007.

(51) Int. Cl. B60R 21/015

(52) U.S. Cl. 297/216.11; 297/217.2; 297/217.3; 297/217.6

(57) ABSTRACT

A child restraint system is provided for detecting and indicating whether a vehicle seat belt is sufficiently tensioned to secure a child seat onto a seat of a vehicle and whether a child seat harness is sufficiently tensioned to restrain a child within the child seat. The child restraint system includes a vehicle seat belt tension sensor and status indicator and a child seat harness tension sensor and status indicator. The child restraint system further includes an occupant sensor for determining whether a child is seated within the child seat. If the occupant sensor determines that a child is seated within the child seat, the vehicle seat belt status indicator is disabled, thereby preventing the weight of the child from interfering with the proper installation of the child seat onto the seat of the vehicle by applying a downward force to the vehicle seat belt tension sensor.

### CROSS-REFERENCE TO RELATED APPLICATION

This application claims the benefit of U.S. Provisional Application No. 60/909,746 filed on Apr. 3, 2007.

### BACKGROUND OF THE INVENTION

This invention relates generally to child restraint systems, and more particularly, to a child restraint system including at least one tension sensor and status indicator for detecting and indicating whether a vehicle seat belt or child seat harness is sufficiently tensioned. The child restraint system may also include an occupancy sensor for detecting whether the child seat is occupied.

A child restraint system, commonly referred to as a child car seat, child safety seat, or simply, a child seat, is used for transporting and safely restraining a child within a vehicle so as to minimize the risk of injury to the child in the event of an abrupt movement or a collision involving the vehicle. The design of the child restraint system is based upon the size and weight, and to some extent, the age of the child. A rear-facing child seat is recommended for use with infants until at least 1 year of age and weighing less than 20 pounds (9 kg), and should not be used with a child weighing more than 33 pounds (15 kg). A typical rear-facing child seat includes a removable carrier portion adapted to be mounted on a base that is secured onto a seat within a vehicle using a vehicle seat belt. The carrier portion includes a shoulder and chest harness to restrain the infant within the child seat. For children over the age of 1 year, less than about 49 inches (124 cm) in height and weighing less than about 65 pounds (29 kg), a forward-facing child seat is recommended. A forward-facing child seat may be a single-piece that is placed on a seat within a vehicle and secured to the seat using a vehicle seat belt. Alternatively, a forward-facing child seat may include a removable seat portion adapted to be mounted on a base that is secured onto a seat of a vehicle in much the same manner as a rear-facing child seat. Similar to the carrier portion of the rear-facing child seat, the seat portion of the forward-facing child seat likewise includes a shoulder and chest harness to restrain the child within the child seat. Children up to 8 years of age and between about 65 pounds (29 kg) and about 100 pounds (39 kg) are typically seated in a child booster seat that is placed on a seat within the vehicle with the child and the booster seat restrained by a vehicle seat belt.

All of the aforementioned child restraint systems must be properly installed and adjusted in order to provide maximum safety to the infant or child. In particular, the vehicle seat belt that secures the base of the rear-facing child seat or the forward-facing child seat onto the seat of the vehicle must be tensioned sufficiently to prevent the child seat from sliding forward, sliding sideways, or tilting forward (i.e. rotating) excessively in the event of an abrupt movement or collision. Similarly, the shoulder and chest harness of the child seat must be tensioned sufficiently to properly restrain the infant or child within the carrier portion or the seat portion of the child seat. Various tension sensors exist for detecting whether the vehicle seat belt and/or the child seat harness are sufficiently tensioned and/or properly adjusted. Certain of these tension sensors further include a status indicator for indicating whether the vehicle seat belt and/or the child seat harness are sufficiently tensioned. The existing tension sensors and status indicators, however, are relatively complex. As a result, they are inherently unreliable and prone to failure. These complex tension sensors and status indicators are also relatively expensive. Thus, the overall cost of a child restraint system including such a tension sensor and status indicator is significantly increased, resulting in fewer child restraint systems in use that provide additional safety features.

Accordingly, it is recognized that a need exists for a child restraint system that includes a tension sensor and status indicator for detecting and indicating when a sufficient amount of tension has been applied to a vehicle seat belt to secure a child seat onto a seat of a vehicle. A similar need exists for a child restraint system that includes a tension sensor and status indicator that detects and indicates when a sufficient amount of tension has been applied to a child seat harness to properly restrain an infant or child within a child seat. Such a tension sensor and status indicator must be relatively simple to manufacture and operate so as to be reliable and rugged. Furthermore, such a tension sensor and status indicator should not significantly increase the overall cost of the child restraint system so that a greater number of child restraint systems are in use that provide additional safety features.

### BRIEF SUMMARY OF THE INVENTION

In one aspect, the present invention provides a child restraint system that includes at least one tension sensor and status indicator for detecting and indicating whether a vehicle seat belt is sufficiently tensioned to secure a child seat onto a seat of a vehicle. The vehicle seat belt tension sensor preferably includes a pair of front load sensors and a rear location sensor that are depressed a predetermined amount when the vehicle seat belt is properly tensioned. The vehicle seat belt status indicator preferably includes an illumination source having a feature for indicating the status of the front load sensors and the rear location sensor. In one embodiment, the feature includes a green LED for indicating that the vehicle seat belt is sufficiently tensioned to secure the child seat onto the seat of the vehicle and a red LED for indicating that the vehicle seat belt is not sufficiently tensioned.

In another aspect, the present invention provides a child restraint system that includes at least one tension sensor and status indicator for detecting and indicating whether a child seat harness is sufficiently tensioned to properly restrain an infant or child within a child seat. The child seat harness tension sensor preferably includes a hinged sensor plate that rotates against the biasing force of a coil spring relative to a sensor when the child seat harness is properly tensioned. The child seat harness status indicator preferably includes an illumination source having a feature for indicating the status of the tension sensor. In one embodiment, the feature includes a green LED for indicating that the child seat harness is sufficiently tensioned to restrain the child within the child seat and a red LED for indicating that the child seat harness is not sufficiently tensioned.

In yet another aspect, the present invention provides a child restraint system that includes a vehicle seat belt tension sensor and status indicator for detecting and indicating whether a vehicle seat belt is sufficiently tensioned to secure a child seat within a vehicle. The child restraint system further includes a child seat harness tension sensor and status indicator for detecting and indicating whether a child seat harness is sufficiently tensioned to properly restrain an infant or child within the child seat. The vehicle seat belt tension sensor and status indicator preferably includes a pair of front load sensors and a rear location sensor that are depressed a predetermined amount when the vehicle seat belt is properly tensioned, and an illumination source having a feature for indicating the status of the front load sensors and/or the rear location sensor. The child seat harness tension sensor and status indicator includes a hinged sensor plate that rotates against the biasing force of a coil spring past a sensor when the child seat harness is properly tensioned, and an illumination source having a feature for indicating the status of the sensor plate. In one embodiment, the features include a green LED for indicating that the vehicle seat belt and/or the child seat harness are sufficiently tensioned and a red LED for indicating that the vehicle seat belt and/or child seat harness are not sufficiently tensioned.

In yet another aspect, the present invention provides a child restraint system for detecting and indicating whether a vehicle seat belt is sufficiently tensioned to secure a child seat onto a seat of a vehicle and whether a child seat harness is sufficiently tensioned to properly restrain an infant or child within the child seat. The child restraint system includes both a vehicle seat belt tension sensor and status indicator and a child seat harness tension sensor and status indicator. The child restraint system further includes an occupant sensor for determining whether a child is seated within the child seat. If the occupant sensor determines that a child is seated within the child seat, the vehicle seat belt tension sensor and status indicator is disabled, thereby preventing the weight of the child from interfering with the proper installation of the child seat onto the seat of the vehicle by applying a downward force to the front load sensors and the rear location sensor.

### BRIEF DESCRIPTION OF THE DRAWINGS

A child restraint system according to the present invention is best understood by reference to the following description taken in conjunction with the accompanying drawing figures in which:

FIG. 1 is an environmental perspective view showing a child restraint system according to the present invention secured to a vehicle seat;

FIG. 2 is a perspective view of the bottom of the child restraint system of FIG. 1 removed from the vehicle seat for purposes of clarity;

FIG. 3 is a perspective view of the base of a child restraint system according to the present invention with the lower molding of the base removed for purposes of clarity;

FIG. 4 is a plan view of the bottom of the base of FIG. 3;

FIG. 5 is a perspective view of a vehicle seat belt tension sensor for a child restraint system according to the present invention;

FIG. 6 is a perspective view of a typical load sensor of the vehicle seat belt tension sensor of FIG. 5;

FIG. 7 is a detail perspective view of a typical location sensor of the vehicle seat belt tension sensor of FIG. 5 positioned within the base of a child restraint system;

FIG. 8 is a front right-hand perspective view of a bezel assembly for a child restraint system according to the present invention;

FIG. 9 is a rear left-hand perspective view of the bezel assembly of FIG. 8;

FIG. 10 is an exploded perspective view of the bezel assembly as shown in FIG. 8;

FIG. 11 is an exploded perspective view of the bezel assembly as shown in FIG. 9;

FIG. 12 is a front perspective view of a control unit assembly for a child restraint system according to the present invention shown in an inverted configuration;

FIG. 13 is a rear perspective view of the control unit assembly of FIG. 12 shown with the cover removed for purposes of clarity;

FIG. 14 is a rear perspective view of the control unit assembly of FIG. 13 shown in an operational configuration;

FIG. 15 shows detail perspective views of the child seat harness tension sensor of the control unit assembly of FIG. 12;

FIG. 16 is a perspective view of an occupant sensor plate for a child restraint system according to the present invention;

FIG. 17 is a wiring and logic schematic illustrating the operation of a child restraint system according to the present invention; and

FIG. 18 is a flow chart illustrating the operation of a child restraint system according to the present invention.

### DETAILED DESCRIPTION OF THE INVENTION

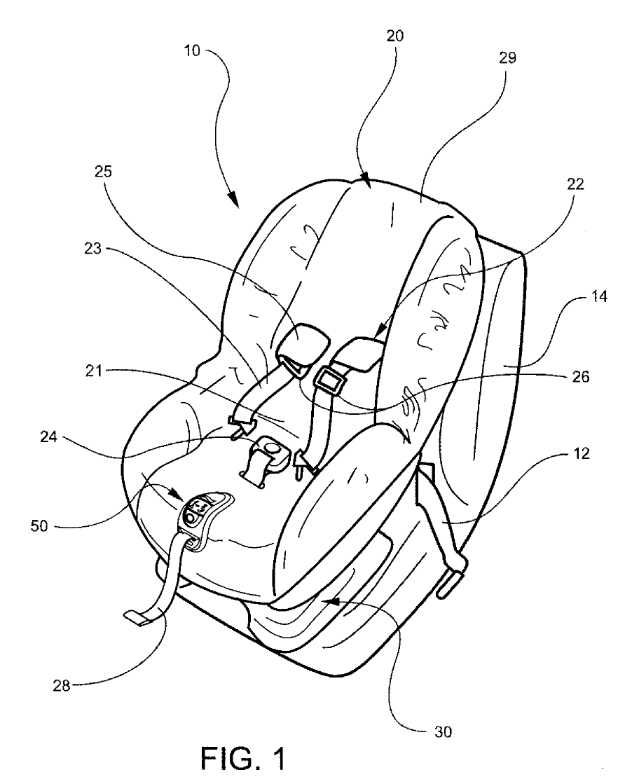

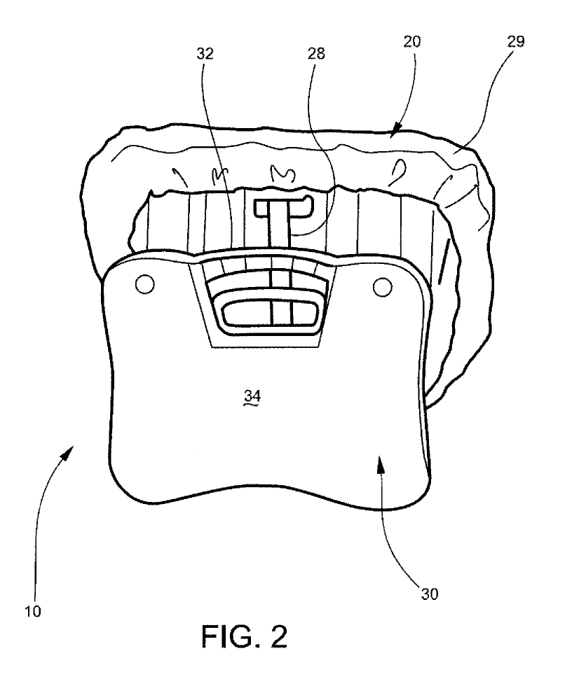

Referring to the drawings wherein identical reference numerals denote like elements throughout the various views, a child restraint system, commonly referred to as a child car seat, child safety seat, or child seat, is shown in FIG. 1 and FIG. 2. The child restraint system, indicated generally at 10, is shown in FIG. 1 secured by a vehicle seat belt 12 onto a seat 14 of the type typically installed in a vehicle (not shown), such as an automobile, bus, train, airplane, etc. As shown and described herein, the forward-facing child seat 10 comprises a seat portion 20 mounted on a base 30 in a known manner. However, the present invention is equally applicable to a rear-facing child seat comprising a removable carrier portion mounted on a base of the type commonly used to transport and safely restrain an infant or small child weighing no more than 33 pounds (15 kg). Preferably, the base 30 and the seat portion 20 (or carrier portion) are molded from a relatively rigid, hard plastic or composite material. As shown, the vehicle seat belt 12 is a conventional lap belt, however, the vehicle seat belt may also be a combination lap belt and shoulder harness of the type often encountered in a vehicle.

The seat portion 20 defines a seat area 21 for seating a child and comprises a child seat harness 22 for restraining the child within the seat area of the child seat 10. The child seat harness 22 comprises a pair of adjustable shoulder and chest straps 23 that are secured to a fixed length harness buckle 24 by conventional tongues or clasps provided on the shoulder and chest straps. The harness 22 may also comprise a pair of pads 25 and a chest clip 26 for providing additional comfort and security. The seat portion 20 further comprises a bezel assembly 50, described in greater detail hereinafter, that receives an adjustment strap 28 for adjusting the length (i.e. tension) of the child seat harness 22 on the child in the seat area 21. As will be described further, the adjustment strap 28 may be extended (i.e. pulled) to shorten (i.e. tighten) the harness 22 around the child. Other pads (not shown) or pillows (not shown) may also be positioned on the seat portion 20 and a removable fabric cover 29 placed over the seat portion to provide additional comfort and to protect the child from the relatively rigid, hard material understructure of the child seat 10.

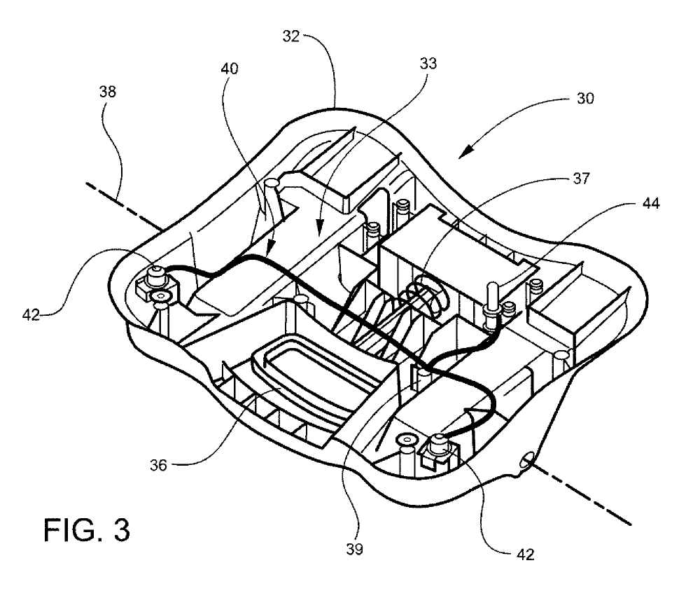

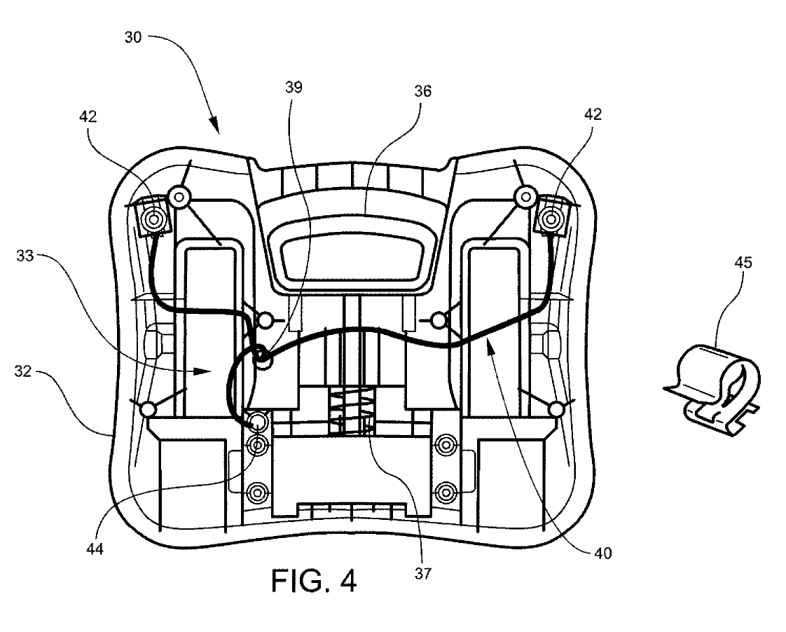

As best shown in FIG. 2, the base 30 comprises an upper molding 32 and a lower molding 34 defining a cavity therebetween. FIGS. 3 and 4 show the base 30 with the upper molding 32 inverted and the lower molding 34 removed to reveal the cavity 33 and components mounted therein. As used herein, the term “inverted” is intended to mean that the base 30 is turned upside-down from the orientation in which the base is placed onto the seat 14 of a vehicle. The upper molding 32 is shaped in a suitable manner to receive the seat portion 20 thereon and the lower molding 34 is shaped to close the upper molding and to provide a relatively flat, stable surface for placing the child seat 10 onto the seat 14 of the vehicle. The base further comprises an adjustment handle 36 for adjusting the recline position of the seat portion 20 relative to the base 30. As shown, the handle 36 may be biased by a conventional coil spring 37 in a locked position to maintain the seat portion 20 in a selected recline position. The recline position may be adjusted by extending (i.e. pulling) the handle 36, rotating the seat portion 20 about a pivot axis 38 (FIG. 3), and then releasing the handle to lock the seat portion in the selected recline position. In addition to housing the adjustment mechanism for the recline position, the upper molding 32 of the base 30 also houses a vehicle seat belt tension sensor assembly 40 for detecting whether the vehicle seat belt 12 is sufficiently tensioned to secure the child seat 10 onto the seat 14 of a vehicle.

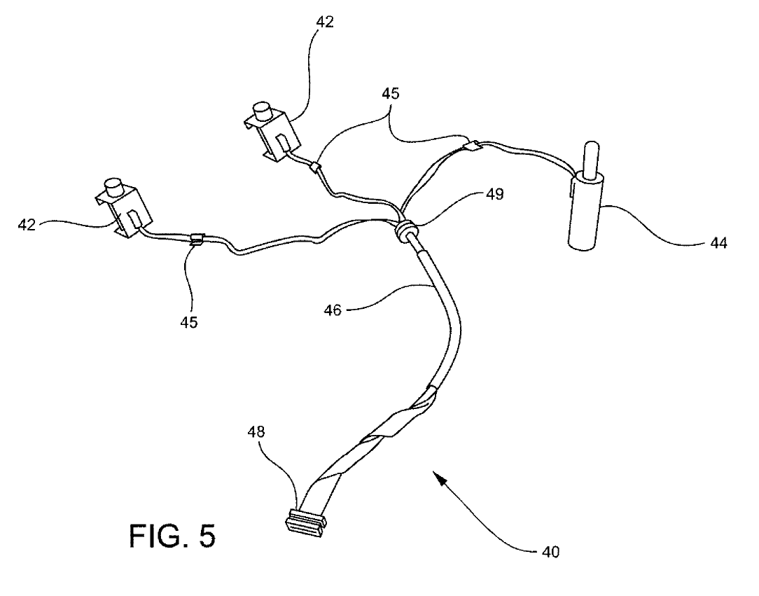

FIG. 5 shows the vehicle seat belt tension sensor assembly 40 in greater detail. The tension sensor assembly 40 comprises at least one tension sensor 42, 44 and a cable 46 terminating in a connector 48 for electrically connecting the sensor(s) to a control unit assembly 60, described hereinafter. As shown, the tension sensor assembly 40 comprises a pair of front load sensors 42 and a rear location sensor 44. In the embodiment illustrated in FIG. 3 and FIG. 4, the front load sensors 42 are positioned within the cavity 33 adjacent the front of the upper molding 32 on opposite lateral sides of the adjustment handle 36. As used herein, the term “front” refers to the portion of the generally rectangular base 30 that is oriented forward when the child seat 10 is secured onto the seat 14 (see FIG. 1). In the embodiment illustrated in FIG. 3 and FIG. 4, the rear location sensor 44 is positioned within the cavity 33 adjacent the rear of the upper molding 32 on one side of the adjustment mechanism 36, 37 for the recline position. As used herein, the term “rear” refers to the portion of the generally rectangular base 30 that is oriented rearward when the child seat 10 is secured onto the seat 14 (see FIG. 1). The cable 46 is routed within the cavity 33 in a convenient manner from the sensors 42, 44 through an access hole 39 formed in the upper molding 32 so that the connector 48 can be routed to the control unit assembly 60. A grommet 49 may be provided to secure the cable 46 within the access hole 39, thereby providing an adequate length of the cable within the cavity 33 and preventing the connector 48 from being inadvertently disconnected. Conventional cable clips 45 may be used as needed to attach and retain the cable 46 to the upper molding 32 of the base 30.

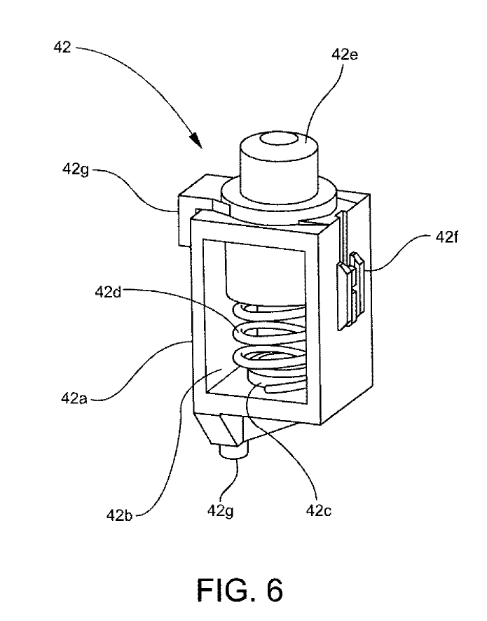

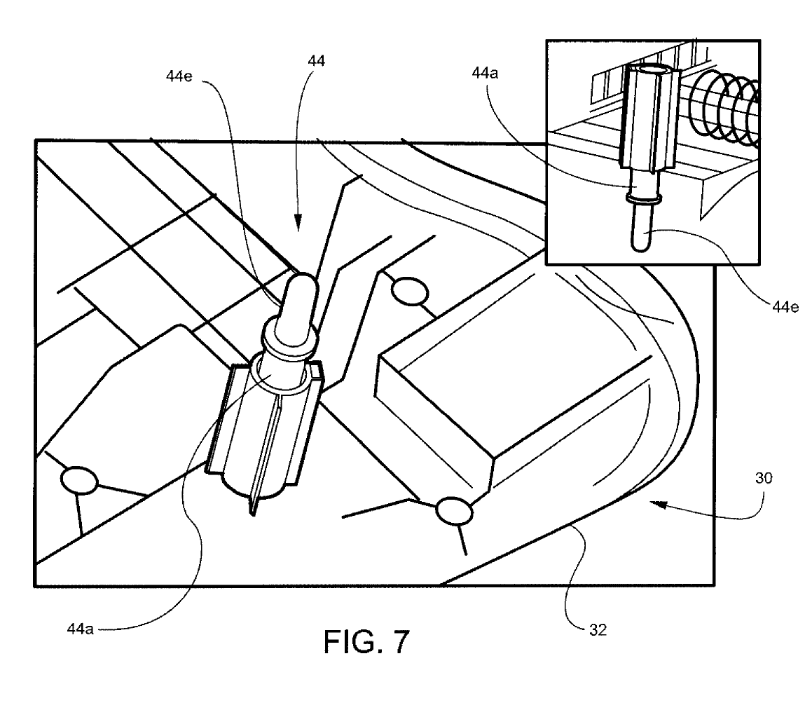

FIG. 6 shows a front load sensor 42 suitable for a child restraint system 10 according to the present invention in greater detail. The load sensor 42 comprises a generally box-shaped body 42a defining a cavity 42b. A magnet 42c and a coil spring 42d are disposed within the cavity 42b. A plunger 42e is partially disposed within the cavity 42b with the coil spring 42d positioned between the plunger and the magnet 42c so that the plunger is biased outwardly relative to the body 42a. The load sensor 42 may further comprise a conventional Hall Effect sensor 42f that is bonded onto an external surface of the body 42a with strain relief for a purpose to be described hereinafter. Features 42g, such as a hook and/or locating pin, are preferably provided to releasably position the sensor 42 on the upper molding 32 of the base 30. FIG. 7 shows a rear location sensor 44 suitable for a child restraint system 10 according to the present invention in greater detail and positioned within the upper molding 32 of the base 30. Similar to sensor 42, the sensor 44 comprises a generally cylindrical body 44a defining a cavity (not shown) that houses a magnet (not shown) and a coil spring (not shown). A plunger 44e is partially disposed within the body 44a and biased outwardly relative to the body by the coil spring. Features (not shown) may be provided to releasably position the sensor 44 on the upper molding 32 of the base 30. Suitable holes are formed through the lower molding 34 for receiving the outwardly biased plungers 42e, 44e such that the plungers extend outwardly from the base 30 in the direction of the seat 14.

Together, the front load sensors 42 and the rear location sensor 44 detect whether the vehicle seat belt 12 is tensioned sufficiently to secure the child seat 10 onto the seat 14 of a vehicle. The child seat 10 (i.e. base 30 with seat portion 20 mounted thereon) is placed onto the seat 14 of a vehicle as illustrated in FIG. 1. The vehicle seat belt 12 is inserted into and passed through the seat portion 20 in the manner recommended by the manufacturer. With the vehicle seat belt 12 loosely attached and without a child seated in the seat area 21 of the seat portion 20, each of the plungers 42e, 44e is biased outwardly from the base 30 by its respective coil spring enough that a weak magnetic field is present between the magnet and a magnetic field sensor. As the vehicle seat belt 12 is tensioned, the plunger 42e, 44e increasingly overcomes the biasing force of the coil spring and moves towards the sensor. When the vehicle seat belt 12 is sufficiently tensioned to secure the child seat 10 onto the seat 14, a stronger magnetic field is formed between the magnet and the sensor. An electrical signal is then transmitted and received at the control unit assembly 60 indicating that the vehicle seat belt 12 is tensioned sufficiently to secure the child seat 10 onto the seat 14. It should be noted that all of the plungers 42e, 44e must be depressed a predetermined amount before the control unit assembly 60 will register a successful attachment of the child seat 10 onto the seat 14.

The embodiments shown and described herein include a pair of front load sensors 42 and a rear location sensor 44. The front load sensors 42 preferably utilize the Hall Effect sensor 42f previously mentioned to determine when the plunger 42e is depressed the predetermined amount that indicates the vehicle seat belt 12 is sufficiently tensioned. However, the front load sensors 42 may utilize any other known sensing means, for example, a mechanical load sensor, an electrical load sensor, an optical load sensor, a proximity switch, a limit switch, an electrical contact switch, an optical continuity switch, etc. The rear location sensor 44 likewise preferably utilizes a Hall Effect sensor to determine when the plunger 44e is depressed the predetermined amount required to indicate the vehicle seat belt 12 is sufficiently tensioned. However, the rear location sensor 44 may utilize any of the other known sensing means mentioned above. The front load sensors 42 respond and transmit a signal to the control unit assembly 60 when a predetermined calibrated load exerted by the vehicle seat belt 12 is sensed. The rear location sensor 44 responds and transmits a signal to the control unit assembly 60 when the rear of the base 30 of the child seat 10 is in sufficiently close contact with the seat 14 of the vehicle.

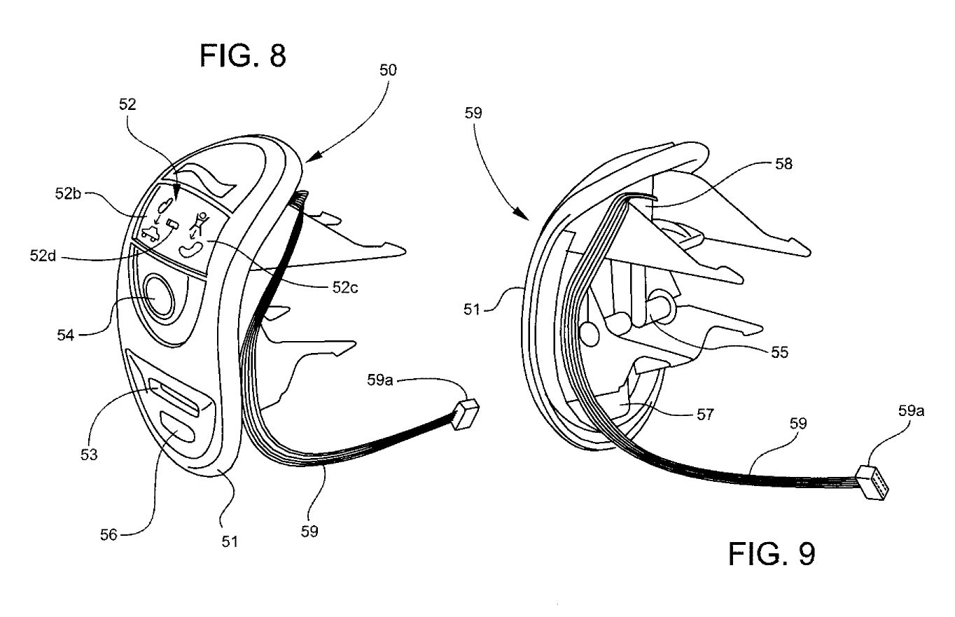

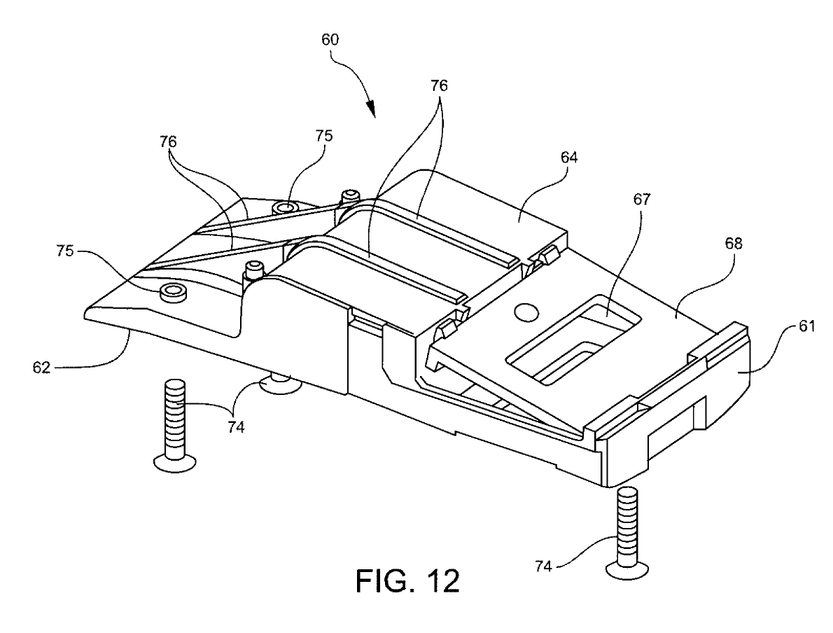

A bezel assembly 50 suitable for use with a child restraint system 10 according to the present invention is shown in FIGS. 8-12. The bezel assembly 50 is preferably formed of a relatively rigid, hard plastic or composite material and is located within an opening formed through the front of the seat portion 20 in proximity to the base 30 (see FIG. 1). As shown, the bezel assembly 50 comprises a body 51 having a status indicator 52 positioned in a visibly accessible location on the outer surface of the body. A slot 53 is formed through the body 51 for receiving the adjustment strap 28 therethrough and a spring-biased release button 54 is provided on the body for engaging an actuator lever 55 that releases the tension on the child seat harness 22. When the release button 54 is depressed, the actuator lever 55 activates a releasable locking mechanism, for example a conventional A-lock, to permit a user to extend (i.e. loosen) the child seat harness 22, thereby retracting the adjustment strap 28 through the slot 53. The bezel assembly 50 further comprises a test button 56 that mechanically engages a test switch 57 to activate one or more tension sensors and status indicators of the child restraint system 10, as will be described, to determine whether the vehicle seat belt 12 is sufficiently tensioned to secure the child seat onto the seat 14 of a vehicle and/or the child seat harness 22 is sufficiently tensioned to properly restrain the child within the child seat.

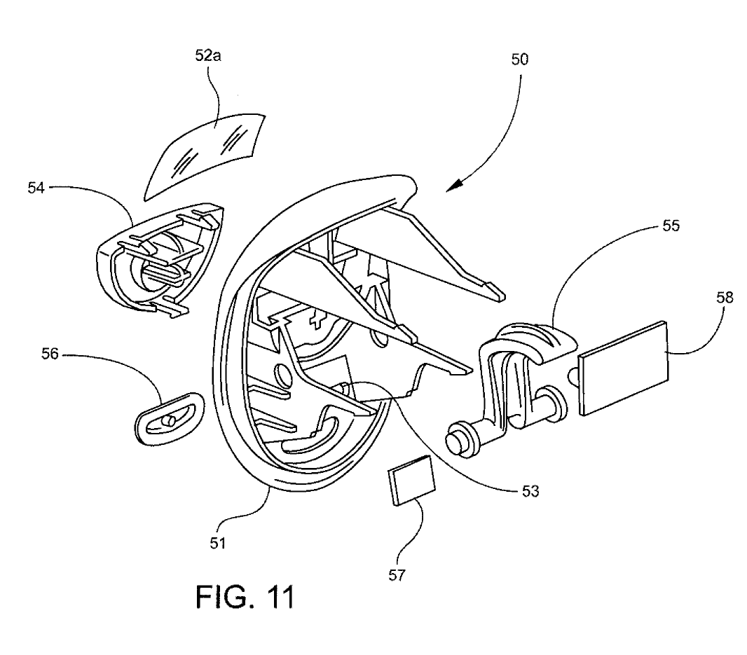

The status indicator 52 comprises a lens 52a (FIG. 10) and at least one feature operable for indicating the status of a tension sensor. As shown, the status indicator 52 comprises a first feature 52b for indicating the status of the tension of the vehicle seat belt 12, and a second feature 52c for indicating the status of the tension of the child seat harness 22. In particular, the first feature 52b is operable to indicate whether the vehicle seat belt 12 is sufficiently tensioned to secure the child seat 10 onto the seat 14 of the vehicle. Similarly, the second feature 52c is operable to indicate whether the child seat harness 22 is sufficiently tensioned to restrain the child within the child seat 10. A child restraint system 10 according to the present invention may include only first feature 52b or only second feature 52c. However, child restraint system 10 typically includes both features 52b, 52c since optimum safety is achieved when both the child seat is properly secured onto the seat 14 of the vehicle and the child is properly restrained within the child seat by the child seat harness 22. The lens 52a may be co-molded with the body 51 of the bezel assembly 50, or may be a separate lens that is affixed to an inner or outer surface of the body. Alternatively, the lens 52a may be fitted to the body 51 during the curing process in order to minimize any potential gaps between the lens and the body. If separate, the lens 52a may be embossed with an icon of the features 52b, 52c. In either instance, the lens 52a may be tinted or colored as desired to match or contrast the color of the body 51.

Regardless, the bezel assembly 50 further comprises an illumination source 58, such as a light-emitting diode (LED) circuit board, that illuminates the features 52b, 52c through the lens 52a to indicate the status of the tension of the vehicle seat belt 12 and the child seat harness 22, respectively. Preferably, the illumination source 58 includes a red LED for indicating insufficient tension of the vehicle seat belt 12 or child seat harness 22, and a green LED for indicating sufficient tension of the vehicle seat belt 12 or the child seat harness 22 in an intuitive manner. The illumination source (i.e. LED circuit board) 58 is electrically connected to the control unit assembly 60 by a conventional cable 59 terminating in a connector 59a. Although not shown herein, the test switch 57 is likewise electrically connected to the control unit assembly 60 by a conventional cable and connector in a known manner. The cable 59 for the illumination source 58 and the cable for the test switch 57 are routed in close proximity to the side of the body 51 of the bezel assembly 50 so that the entire bezel assembly can be easily inserted through the opening formed in the seat portion 20 of the child seat 10 without crimping, cutting or otherwise damaging either cable. As a result, bezel assembly 50 can be installed as a unit and can be readily removed for repair or replacement in the event of damage or failure.

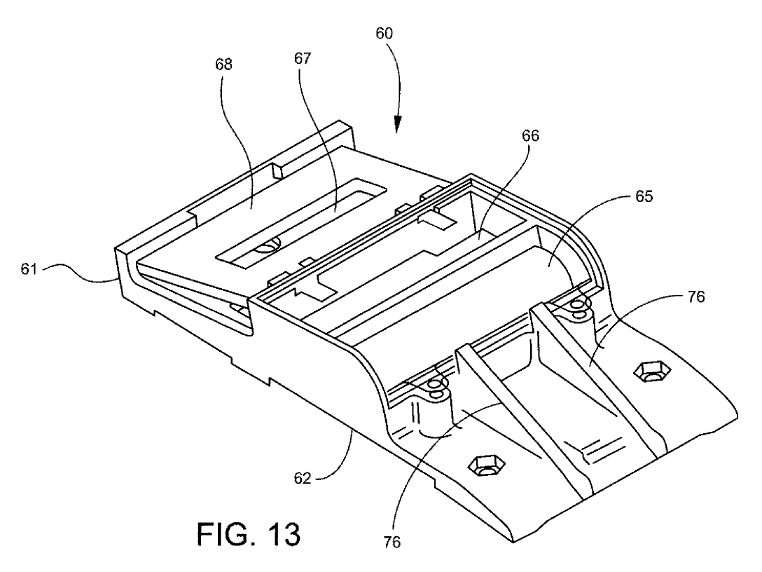

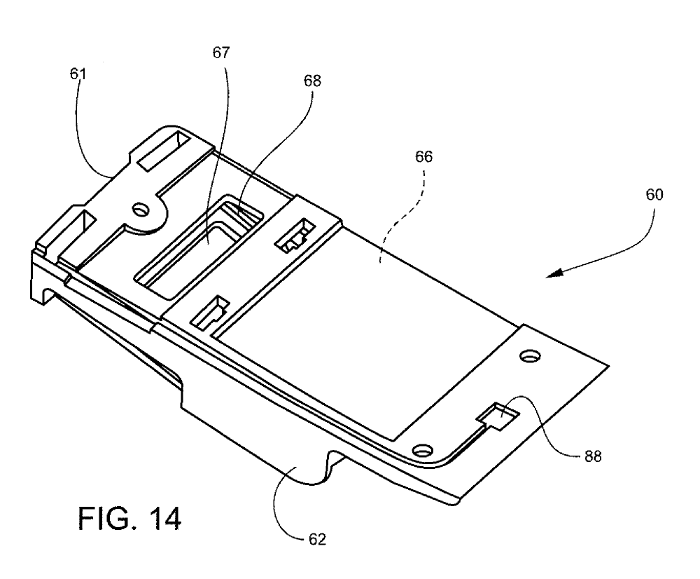

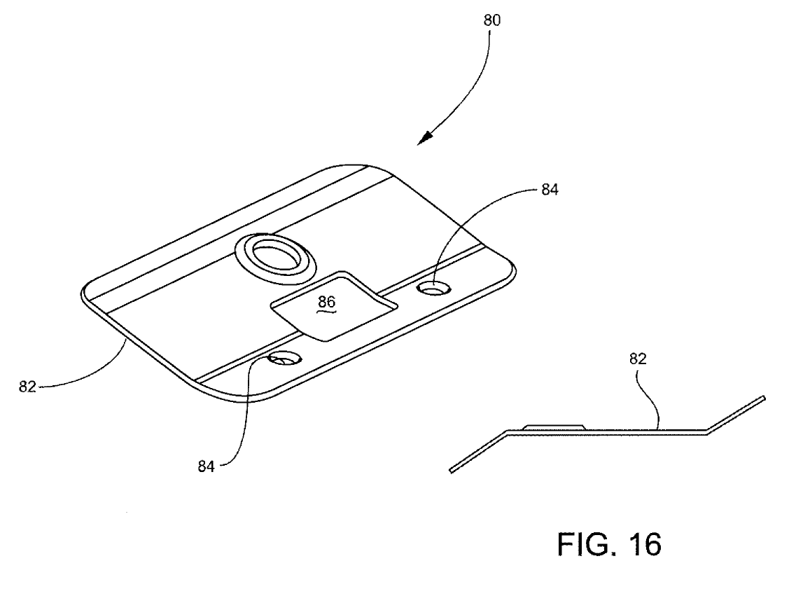

A control unit assembly 60 suitable for use with a child restraint system 10 according to the present invention is shown in FIGS. 12-15. As shown, the control unit assembly 60 comprises a control unit body 62 and control unit cover 64 defining a cavity or compartment for housing a controller 66 and a power source 65, such as a conventional battery. The controller 66 may comprise any electrical circuit, but preferably is a conventional printed circuit board (PCB) electrically connected to the battery 65. The control unit assembly 60 includes a child seat harness sensor comprising a sensor plate 68 having a slot 67 formed therethrough. As best shown in FIG. 15, the sensor plate 68 is hinged along one side to a first end 61 of the control unit body 62. The opposite side of the sensor plate 68 is biased outwardly away from the control unit body 62 by a conventional coil spring 70 and retained on the control unit body against the biasing force of the coil spring by at least one retaining tab 72. The control unit body 62 is attached to the underside of the seat portion 20 by a plurality of fasteners 74 (FIG. 12), such as threaded bolts or machine screws, that pass through the seat portion 20 and engage fixed nuts 75 provided on the control unit body. The control unit assembly 60 is attached to the seat portion 20 such that the slot 67 of the sensor plate 68 is in registration with the slot 53 of the body 51 of the bezel assembly 50. The adjustment strap 28 is routed from the child seat harness 22 over raised guides 76, for example ribs or rails formed on the control unit body 62 and the control unit cover 64, to the sensor plate 68. The adjustment strap 28 then passes through the slot 67 of the sensor plate 68 and through the slot 53 of the body 51 of the bezel assembly 50. In this manner, the sensor plate 68 rotates about the hinged side adjacent first end 61 against the biasing force of the coil spring 70 in the direction of the control unit body 62.

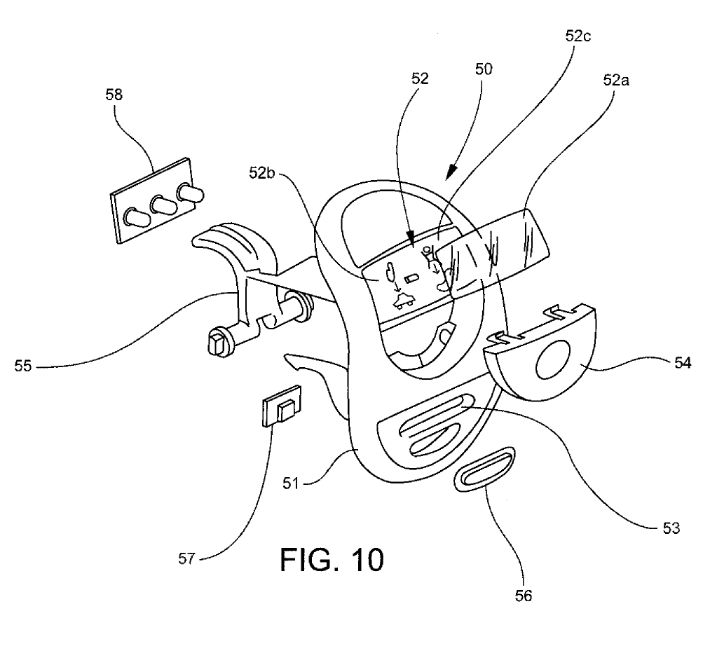

As previously mentioned, the connector 48 on the cable 46 of the tension sensor assembly 40 (FIG. 5) is routed from the base 30 of the child seat 10 to the control unit assembly 60. Likewise, the connector 59a on the cable 59 is routed from the illumination source 58 of the bezel assembly 50 (FIG. 9) to the control unit assembly 60 and a cabled connector (not shown) from the test switch 57 is routed from the bezel assembly 50 to the control unit assembly 60. In particular, the connectors are each routed to the controller 66 and electrically connected thereto in a known manner, for example by plugging the male or female connector directly onto a female or male receptacle provided on the PCB. A harness sensor first portion 68a (FIG. 15) is provided on the sensor plate 68 and a harness sensor second portion 68b (FIG. 15) is mounted on the controller 66 for reading the first portion. For example, the harness sensor first portion 68a and the corresponding harness sensor second portion 68b may comprise a mechanical load sensor, an electrical load sensor, an optical load sensor, a proximity switch, a limit switch, an electrical contact switch, an optical switch, etc. As shown and described herein, the harness sensor first portion 68a is a magnet and the harness sensor second portion 68b is a magnetic transducer for sensing the proximity of the magnet. In particular, the transducer senses the magnet approaching the transducer as the sensor plate 68 rotates when the adjustment strap 28 of the child seat harness 22 is tightened. The sensor then transmits an electrical signal to the controller 66 once the magnet is in sufficient proximity to the sensor. In other words, the harness first sensor portion 68a “trips” the harness second sensor portion 68b to alert the controller 66 that the child seat harness 22 is tightened sufficiently to restrain the child within the child seat 10.

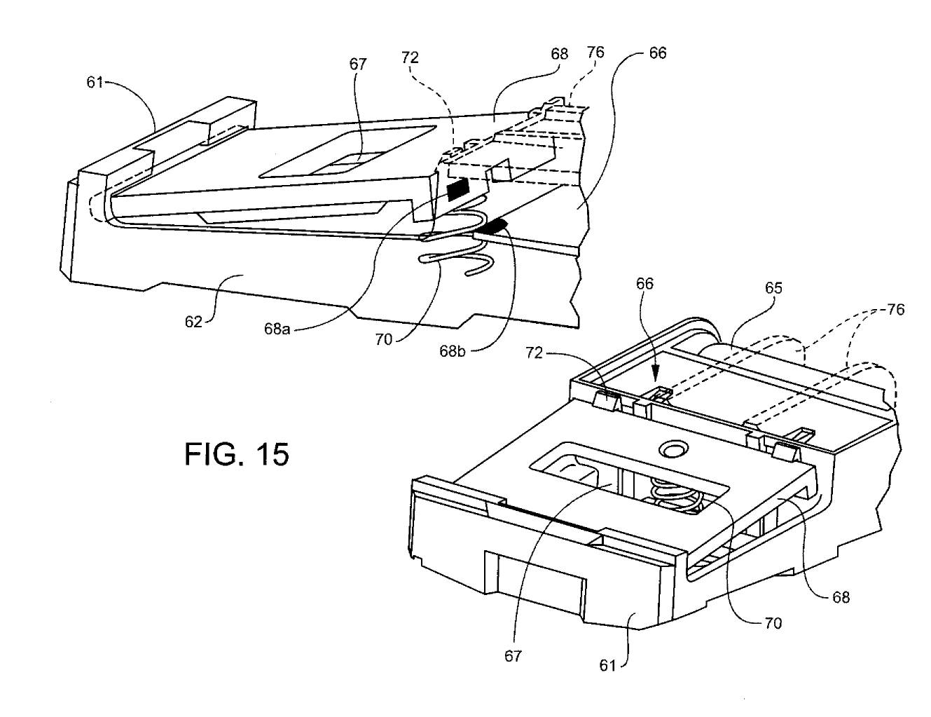

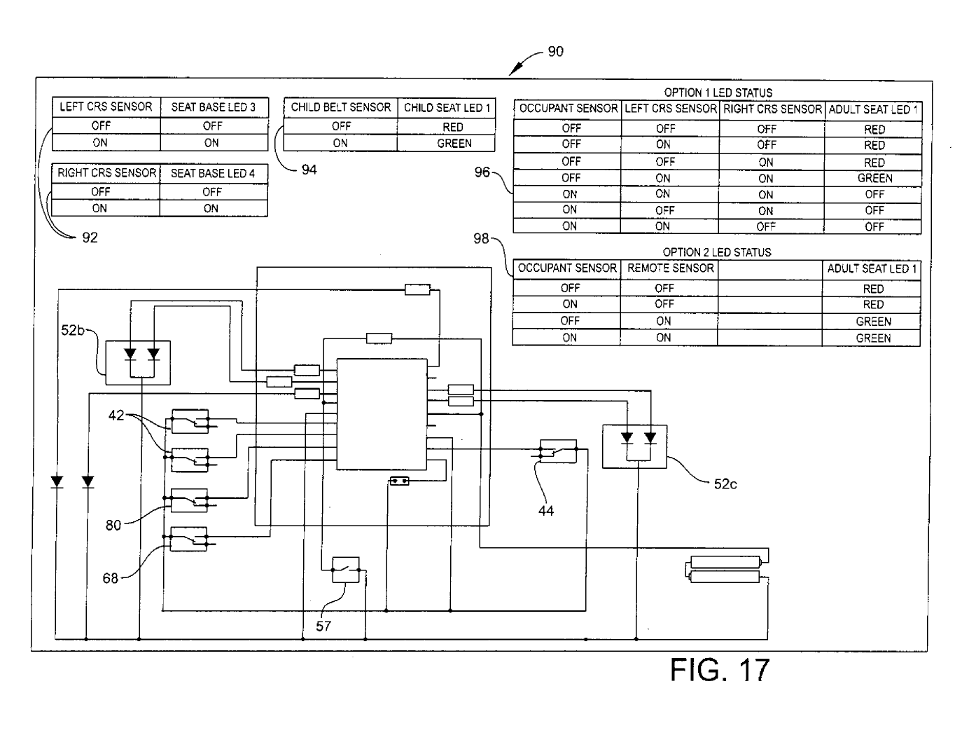

An occupant sensor assembly 80 suitable for use with a child restraint system 10 according to the present invention is shown in FIG. 16. The occupant sensor assembly 80 comprises an occupant sensor plate 82 having at least one, and as shown, a pair of through holes 84 for receiving fasteners 74 FIG. 12) to secure the occupant sensor plate to the control unit body 62. The sensor plate 82 further has a window 86 formed therethrough for providing access to an occupant sensor switch 88 (FIG. 14) mounted on the control unit body 62. The occupant sensor plate 82 is pre-formed in an arcuate shape and mechanically supported in a cantilevered fashion by the fasteners 74 received in through holes 84. As a result, the plate 82 is inherently spring-loaded and biased outwardly from control unit body 62. The plate 82 is essentially straightened by the application of an occupant load (i.e., a downward force) generated by the weight of a child seated within the seat area 21 of the seat portion 20 of the child seat 10. (It should be noted that the occupant sensor plate 82 would also be straightened by a force generated by an installer pressing downwardly against the seat area 21 of the child seat 10). When the plate 82 is straightened, a magnet (not shown) disposed on the underside of the plate moves towards the sensor 88 operably positioned on the control unit body 62 beneath the seat portion 20. The sensor, typically a Hall Effect type sensor, transmits an electrical signal to the controller 66 of the control unit assembly 60 to indicate the presence of an occupant (i.e., child) or other downward force within the seat area 21. As best shown in FIG. 14, the sensor is electrically connected to the PCB of the control unit assembly 60 by a cable routed along the control unit body 62 and into the cavity defined by the control unit body and the control unit cover 64. The occupant sensor assembly 80 is operable to determine whether a child is seated within the seat portion 20 of the child seat 10. The occupant sensor may be any known sensor, for example an electrical contact switch, an electrical load sensor, an optical load sensor, a proximity switch, a load cell, a strain gage, etc. Regardless, the occupant sensor transmits an electrical signal to the controller 66 that indicates when a child is seated within the child seat 10, for a purpose to be described.

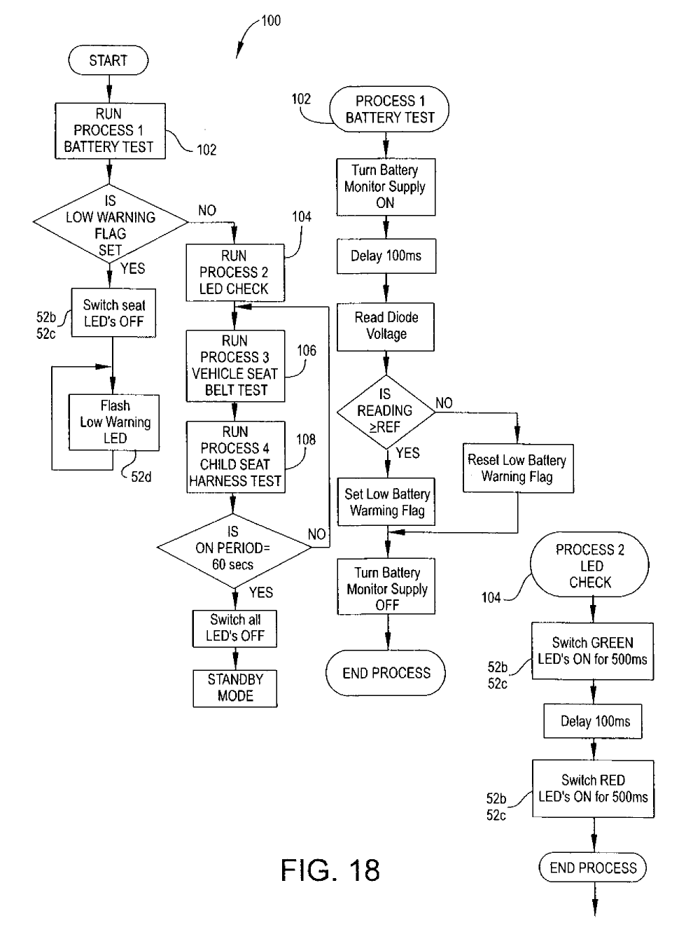

FIG. 17 shows a wiring and logic schematic 90 for various embodiments of a child restraint system 10 according to the present invention. The wiring and logic schematic 90 includes a first logic chart 92 that illustrates the operation of an exemplary embodiment of the child restraint system 10. In this embodiment, the first feature 52b of the status indicator 52 is disabled (“OFF”) to indicate that the vehicle seat belt 12 is not sufficiently tensioned to secure the child seat 10 onto the seat 14 of the vehicle when either the left front load sensor 42 or the right front load sensor 42 is not depressed (“OFF”). Conversely, the first feature 52b of the status indicator 52 is enabled (“ON”) to indicate that the vehicle seat belt is sufficiently tensioned when both the front load sensors 42 are depressed (“ON”). The wiring and logic schematic 90 includes a second logic chart 94 that illustrates the operation of an exemplary embodiment of the child restraint system 10 in which the second feature 52c of the status indicator 52 indicates that the child seat harness 22 is not sufficiently tensioned (“RED”) when the sensor plate 68 of the child seat harness sensor is not rotated (“OFF”). Conversely, the second feature 52c of the status indicator indicates that the child seat harness 22 is sufficiently tensioned (“GREEN”) when the sensor plate 68 of the child seat harness sensor is rotated (“ON”). The wiring and logic schematic 90 includes a third logic chart 96 that illustrates the operation of an exemplary embodiment of the child restraint system 10 in which the first feature 52b of the status indicator 52 is disabled (“OFF”) whenever the occupant sensor 80 indicates that a child is seated within the seat area 21 of the child seat 10 (“ON”). When the occupant sensor 80 indicates that a child is not seated within the seat area 21 (“OFF”), the first feature 52b of the status indicator 52 indicates that the vehicle seat belt 12 is sufficiently tensioned (“GREEN”) when both the front load sensors 42 are depressed (“ON”). The wiring and logic schematic 90 includes a fourth logic chart 98 that illustrates the operation of an exemplary embodiment of the child restraint system 10 in which the first feature 52b of the status indicator 52 indicates that the vehicle seat belt 12 is sufficiently tensioned (“GREEN” whenever the rear location sensor 44 is depressed (“ON”), regardless of whether the occupant sensor is “ON” or “OFF.”

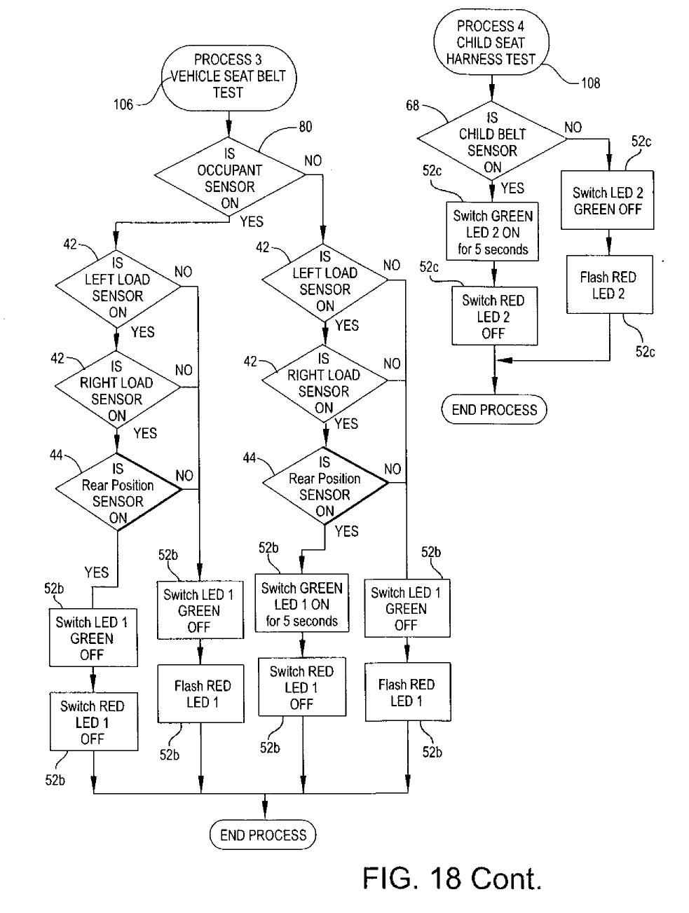

FIG. 18 shows a flow chart 100 for a child restraint system 10 according to the present invention. The flow chart 100 illustrates an exemplary embodiment of the operation of a child restraint system 10 when the test button 56 located on the body 51 of the bezel assembly 50 is pressed to activate the test switch 57. The flow chart 100 includes the operation 102 of running a battery test to determine whether there is enough voltage in the battery 65 to conduct a reliable status check of the tension of the vehicle seat belt 12 and/or the child seat harness 22. If a diode voltage reading of a fixed reference is greater than or equal to a value proportional to a predetermined low battery voltage, a “LOW BATTERY” warning flag is set and the low battery indicator 52d (see also FIG. 8) on the status indicator 52 of the bezel assembly 50 is flashed (or illuminated). In a LOW BATTERY condition, the first and second features 52b and 52c of the status indicator 52 are switched off to disable the status indicator function of the child restraint system 10. If the “LOW BATTERY” warning flag is not flashed (or illuminated), the GREEN LED and the RED LED of the illumination source 58 are checked at operation 104 for proper illumination. Assuming the LEDs of the illumination source 58 are operating properly, the flow chart includes the operation 106 to determine whether the vehicle seat belt 12 is tensioned sufficiently to secure the child seat 10 onto the seat 14 of the vehicle. The operation 106 first determines whether a child is seated within the seat area 21 of the seat portion 20 (i.e. the occupant sensor is “ON”). If the occupant sensor is “ON” and the front load sensors 42 and rear location sensor 44 are depressed (“ON”), both the GREEN LED and the RED LED of the first feature 52b are switched “OFF” to disable the status indicator function. This is a safety feature to prevent the child restraint system 10 from indicating a “false positive” due to the weight of a child seated within the seat area 21 of the seat portion 20. If the occupant sensor is “ON,” but the front load sensors 42 and rear location sensor 44 are not depressed (“OFF”), the RED LED of the first feature 52b is flashed to indicate that the vehicle seat belt 12 is not sufficiently tensioned. If the occupant sensor is “OFF” and the front load sensors 42 and the rear location sensor 44 are depressed (“ON”), the GREEN LED of the first feature 52b is illuminated for a pre-selected time and the RED LED of the feature 52b is switched “OFF.” Conversely, if the occupant sensor is “OFF,” but the front load sensors 42 and the rear location sensor 44 are not depressed (“OFF”), the GREEN LED of the first feature 52b is switched “OFF” and the RED LED of the first feature 52b is flashed for a pre-selected time. The flow chart includes the further operation 108 to determine whether the child seat harness 22 is tensioned sufficiently to restrain the child within the seat portion 20 of the child seat 10. The operation 108 determines whether the sensor plate 68 of the child seat harness sensor is rotated (“ON”) or not rotated (“OFF”). If the sensor plate 68 is “ON,” the GREEN LED of the second feature 52c is illuminated for a pre-selected time and the RED LED of the second feature 52c is switched “OFF.” Conversely, if the sensor plate 68 is “OFF,” the GREEN LED of the second feature 52c is switched “OFF” and the RED LED of the second feature 52c is flashed for a pre-selected time.

The foregoing has described one or more exemplary preferred embodiments of a child restraint system including at least one tension sensor and at least one status indicator. While particular embodiments of the present invention have been described, it will be apparent to those skilled in the art that various modifications thereto can be made without departing from the spirit and scope of the invention. Accordingly, the foregoing description of the preferred embodiments of the invention and the best mode for practicing the invention are provided for the purpose of illustration only and not for the purpose of limitation.

That which is claimed is:

1. A child restraint system comprising:
a child seat including a base and a seat portion mounted on the base; and
at least one tension sensor and status indicator operably connected for detecting and indicating whether a vehicle seat belt is sufficiently tensioned to secure the child seat onto a seat of a vehicle, the tension sensor including at least one front load sensor and at least one rear location sensor that are each depressed a predetermined amount when the vehicle seat belt is sufficiently tensioned.

2. The child restraint system of claim 1, wherein the status indicator comprises a feature visibly disposed on the child seat for indicating the status of the tension sensor.

3. The child restraint system of claim 2, wherein the feature comprises a green LED for indicating that the vehicle seat belt is sufficiently tensioned to secure the child seat onto the seat of the vehicle and a red LED for indicating that the vehicle seat belt is not sufficiently tensioned.

4. The child restraint system of claim 1, further comprising a controller electrically connected to the tension sensor and electrically connected to the status indicator.

5. The child restraint system of claim 1, wherein the at least one front load sensor comprises a body defining a cavity, a magnet and a biasing element disposed within the cavity, and a plunger partially disposed within the cavity, and wherein the biasing element is positioned between the plunger and the magnet so that the plunger is biased outwardly relative to the body.

6. The child restraint system of claim 5, wherein the at least one front load sensor further comprises a Hall Effect sensor operably disposed on the body.

7. The child restraint system of claim 1, further comprising an occupant sensor for determining whether a child is seated within the seat portion of the child seat and for disabling the status indicator when a child is seated within the seat portion of the child seat.

8. A child restraint system comprising:
a child seat including a base and a seat portion mounted on the base; and
at least one tension sensor and status indicator operably connected for detecting and indicating whether a child seat harness is sufficiently tensioned to restrain a child within the child seat, the tension sensor including a hinged sensor plate that rotates against a biasing force a predetermined amount when the child seat harness is sufficiently tensioned.

9. The child restraint system of claim 8, wherein the status indicator comprises a feature visibly disposed on the child seat for indicating the status of the tension sensor.

10. The child restrain system of claim 9, wherein the feature comprises a green LED for indicating that the child seat harness is sufficiently tensioned to restrain the child within the child seat and a red LED for indicating that the child seat harness is not sufficiently tensioned.

11. The child restraint system of claim 8, further comprising a controller electrically connected to the tension sensor and electrically connected to the status indicator.

12. The child restraint system of claim 11, further comprising a controller body housing the controller and having a first end for receiving the hinged sensor plate, a magnet disposed on the sensor plate, and a biasing element disposed between the controller body and the sensor plate for applying the biasing force against the sensor plate so that the sensor plate and the magnet are biased outwardly relative to the controller body.

13. The child restraint system of claim 12, further comprising a sensor fixedly disposed on the controller for sensing the proximity of the magnet.

14. A child restraint system comprising:
a vehicle seat belt tension sensor and status indicator for detecting and indicating whether a vehicle seat belt is sufficiently tensioned to secure a child seat within a vehicle,
a child seat harness tension sensor and status indicator for detecting and indicating whether a child seat harness is sufficiently tensioned to restrain a child within the child seat; and
an occupant sensor for determining whether a child is seated within the child seat and for disabling the vehicle seat belt status indicator when a child is seated within the child seat.

15. The child restraint system of claim 14, wherein the vehicle seat belt status indicator comprises a first feature visibly disposed on the child seat for indicating the status of the vehicle seat belt tension sensor, and wherein the child seat harness status indicator comprises a second feature visibly disposed on the child seat for indicating the status of the child seat harness tension sensor.

16. The child restraint system of claim 14, further comprising a controller electrically connected between the vehicle seat belt tension sensor and the vehicle seat belt status indicator, electrically connected between the child seat harness tension sensor and the child seat harness status indicator, and electrically connected to the occupant sensor.

17. The child restrain system of claim 14, wherein the vehicle seat belt tension sensor comprises at least one front load sensor and a rear location sensor that are each depressed a predetermined amount when the vehicle seat belt is sufficiently tensioned, the front load sensor and the rear location sensor each comprising a body defining a cavity, a magnet and a biasing element disposed within the cavity, and a plunger partially disposed within the cavity, and wherein the biasing element is positioned between the plunger and the magnet so that the plunger is biased outwardly relative to the body.

18. The child restraint system of claim 14, wherein the child seat harness tension sensor comprises a hinged sensor plate that rotates against a biasing force a predetermined amount when the child seat harness is sufficiently tensioned, a controller body having a first end for receiving the hinged sensor plate, a magnet disposed on the sensor plate, and a biasing element disposed between the controller body and the sensor plate for applying the biasing force against the sensor plate so that the sensor plate and the magnet are biased outwardly relative to the controller body, and wherein a sensor is fixedly disposed on the controller body for sensing the proximity of the magnet.

19. A method for detecting and indicating whether a vehicle seat belt is sufficiently tensioned to secure a child seat onto a seat of a vehicle, the method comprising:
providing a vehicle seat belt tension sensor and status indicator on the child seat, the vehicle seat belt tension sensor including at least one front load sensor and a rear location sensor that are each depressed a predetermined amount when the vehicle seat belt is sufficiently tensioned, the vehicle seat belt status indicator including a feature visibly disposed on the child seat for indicating the status of the vehicle seat belt tension sensor;
positioning the child seat on the seat of the vehicle with the vehicle seat belt engaging the child seat; and
tensioning the vehicle seat belt until the feature indicates that the vehicle seat belt is sufficiently tensioned to secure the child seat onto the seat of the vehicle.

20. The method of claim 19, further comprising providing an occupant sensor for determining whether a child is seated within the child seat, and disabling the vehicle seat belt status indicator when a child is seated within the child seat.

21. A method for detecting and indicating whether a child seat harness is sufficiently tensioned to restrain a child within a child seat, the method comprising:
providing a child seat harness tension sensor and status indicator on the child seat, the child seat harness tension sensor including a hinged sensor plate that is rotated a predetermined amount when the child seat harness is sufficiently tensioned, the child seat harness status indicator including a feature visibly disposed on the child seat for indicating the status of the child seat harness tension sensor;
positioning the child within the child seat with the child seat harness engaging the child; and
tensioning the child seat harness until the feature indicates that the child seat harness is sufficiently tensioned to restrain the child within the child seat.
